(19) United States
(12) Patent Application Publication
(10) Pub. No.: US 2006/0068712 A1
(43) Pub. Date: Mar. 30, 2006

(54) Method of remotely monitoring and troubleshooting multiple radio network controllers

(76) Inventors: Robert H. Kroboth, Peyton, CO (US); Steve Urvik, Colorado Springs, CO (US); Andy McArthur, Colorado Springs, CO (US)

Correspondence Address: AGILENT TECHNOLOGIES, INC.;Legal Department, DL429, Intellectual Property Administration, P.O. Box 7599, Loveland, CO, 80637-0599, US

(21) Appl. No.: 10/948,682

(22) Filed: Sep. 24, 2004

(51) Int. Cl. H04B 17/00

(52) U.S. Cl. 455/67.11; 455/414.1

(57) ABSTRACT

A method of capturing data across interfaces of multiple radio network controllers, distributing the captured data for correlation on a call basis and then correlating and displaying all the captured data corresponding to each of the multiple radio network controllers. Data is captured across various interfaces of radio network controllers in a cellular network via a plurality of distributed network analyzers. Radio network controller events are identified in the captured data according to cell calls for each radio network controller according to analysis by signaling analyzers. The identified events from each signaling analyzer corresponding to captured data for each radio network controller is remotely analyzed and correlated together across the multiple radio network controllers. The correlated events are then displayed on a user interface to permit easy and quick monitoring of the radio network controllers simultaneously. Accordingly, the method of the present invention allows real time distributed analysis and troubleshooting of the data on the interfaces of N radio network controllers from a single location.

### BACKGROUND OF THE INVENTION

Generally, in a cellular communication system, a given geographical area is divided into multiple cells each of which is served by a Node B (also known as a base station) having a limited signal coverage area. The Node Bs communicate with multiple user equipments wirelessly via radio signals. The Node Bs are part of a Radio Access Network (RAN). The RAN is connected to either a circuit switched core network, which is connected to a public switched telephone network (PSTN) or to a packet switched core network, which is connected to the Internet.

The RAN also includes multiple radio network controllers (RNCs), which serve as switching centers for the Node Bs. The RNC manages all of the wireless radio interfaces of the Node Bs and controls handoff between either the circuit switched core network or the packet switched core network and the Node Bs that are associated with a call. When user equipment, such as a mobile telephone, that is placing a call is moving between a first cell and a second cell, the RNC switches or performs a handoff between a first Node B corresponding to the first cell and a second Node B corresponding to the second cell. Additionally, when the first Node B and the second Node B are connected to different RNCs, then one of the RNCs routes the call to another RNC in the cellular communication system that manages the other Node B. The RNCs have extremely complex processing and are a critical point in the cellular system where problems can occur.

Conventionally, in order to monitor and troubleshoot a RNC, signaling data is captured locally and then analyzed to troubleshoot problems in that RNC of the cellular system. However, because of the large geographic distribution of the RNCs, analyzing each RNC locally presents huge logistical challenges. Additionally, because of the handoffs that occur the signaling data of one RNC may not include all of the data associated with a particular call.

In view of the above, there is a need for a method, which enables multiple RNCs to be monitored from a single location. Further, there is a need that the multiple RNCs can be monitored on a per call basis in order to provide more robust troubleshooting capabilities.

### SUMMARY OF THE INVENTION

According to an aspect of the present invention, a method of monitoring and troubleshooting multiple Radio Network Controllers (RNCs) in a Universal Mobile Telephone System (UMTS) is provided.

According to an aspect of the present invention, a method is provided which includes capturing data across interfaces of a plurality of radio network controllers in the cellular network via a plurality of distributed network analyzers, identifying radio network controller events of the captured data according to a cell call for each radio network controller which handles the cell call according to analysis by signaling analyzers, correlating together the events identified by the signaling analyzers according to the cell call, and analyzing and displaying the correlated events remotely on a user's terminal.

According to an aspect of the present invention, a method is provided of monitoring a cellular network, the cellular network including a core network communicating with a first radio network controller, the first radio network controller having a first plurality of Node Bs corresponding to the first radio network controller, and a second radio network controller, the second radio network controller having a second plurality of Node Bs corresponding to the second radio network controller, the method including: capturing first data flowing between the first radio network controller and at least one Node B of the first plurality of Node Bs; capturing second data flowing between the second radio network controller and at least one Node B of the second plurality of Node Bs; capturing third data flowing between the first radio network controller and the second radio network controller; correlating the captured first, second and third data according to a call; and determining status of the first and second radio network controllers according to the correlated first, second and third data.

In accordance with another aspect of the present invention, a method is provided of monitoring a plurality of radio network controllers in a cellular network, by transmitting a first status report corresponding to detected network data of a first cell call, where the first cell call is associated with a first radio network controller, the status report being transmitted on a packet network connection connecting the first radio network controller with the cellular network; detecting other network data of another cell call on the cellular network corresponding to another radio network controller; transmitting a second status report corresponding to the other network data of the other cell call, the second status report being transmitted on the packet network connection connecting the other radio network controller with the cellular network; and correlating and displaying the first status report and the second status report for the first cell call and the other cell call as a radio network controller report corresponding to the first and the other radio network controller to a user.

In an aspect of the present invention, the user views a general status report of a correlated view of each of the radio network controllers being monitored and may request more detailed data corresponding to a particular radio network controller when an error occurs.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram illustrating a Universal Mobile Telephone System (UMTS) in which embodiments of the present invention are employed;

FIG. 2 is a block diagram illustrating a Radio Network Controller (RNC) and monitoring system, according to an embodiment of the present invention; and

FIG. 3 is a flowchart illustrating the process of remotely monitoring multiple RNCs according to an embodiment of the present invention.

### DETAILED DESCRIPTION OF THE PREFERRED EMBODIMENTS

Reference will now be made in detail to the present embodiments of the present invention, examples of which are illustrated in the accompanying drawings, wherein like reference numerals refer to the like elements throughout. The embodiments are described below to explain the present invention by referring to the figures.

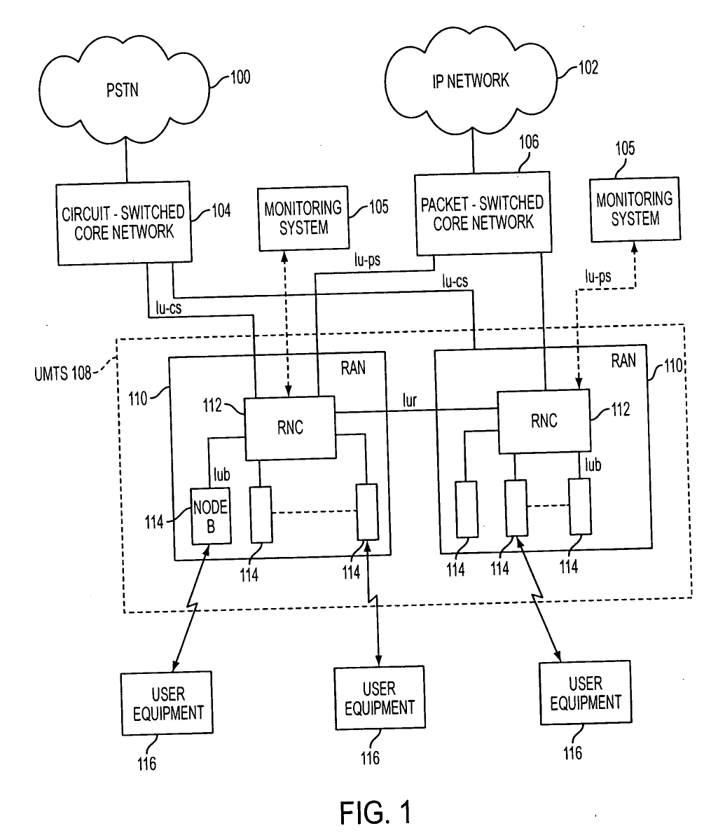

FIG. 1 is a block diagram illustrating an exemplary cellular communication system including a Universal Mobile Telephone System (UMTS) in which embodiments of the present invention are employed. In FIG. 1, network data comprising signaling data and user data of interfaces of multiple Radio Network Controllers (RNCs) are correlated and analyzed. Signaling data refers to information concerned with establishment, control and management of data related to functions of the UMTS 108, and user data refers to information transmitted by user equipment 116 such as voice data, graphical data or text.

Referring to FIG. 1, a first external network 100 is a Public Switched Telephone Network (PSTN). A circuit-switched core network 104 provides data communication switching with the first external network 100. A second external network 102 is a packet switched network such as the Internet. A packet switched core network 106 provides communication switching with the second external network 102 according to the serving general packet radio service node (SGSN).

Both the circuit switched core network 104 and the packet-switched core network 106 connect with the UMTS 108 over an Iu interface, Iu-cs and Iu-ps, respectively. Generally both types of interface are based on asynchronous transfer mode (ATM) technology where data cells and packets are exchanged between each of the core networks 104 and 106 and the UMTS 108.

The UMTS 108 comprises one or more Radio Access Networks (RAN) 110, each having a Radio Network Controller (RNC) 112 interfacing via Iub interfaces with a plurality of Node Bs 114. Node Bs 114, also known as base stations, provide radio interfaces or links to user equipment 116, for example a mobile terminal, outside the UMTS 108. Each Node B 114 provides radio coverage for the user equipments 116 within a particular geographic region known as a cell. The RNC 112 manages the wireless radio interfaces of the Node Bs 114 and controls handoff, sending data from one of the core networks 104 or 106 to one or more Node Bs 114 in the forward direction, and selects the best signal from several Node Bs 114 and sends it to one of the core networks 104 or 106 in the reverse direction. For example, if the user equipment 116 makes a call as it is moving between cells of corresponding Node Bs 114, the RNC will hand over communication responsibilities to an adjacent Node B 114 when the signal between the user equipment 116 and the starting Node B 114 falls below a threshold. Also, when the user equipment 116 will leave the cells covered by the Node Bs 114 associated with a first RNC 112, the first RNC 112 will route the call to another RNC 112 in the UMTS via an Iur interface. It is to be understood that the UMTS 108 is not limited to the general description in FIG. 1 and it is understood that the UMTS 108 may comprise other components and services of a cellular network. Though described with respect to a call, it is understood that the call is not limited to voice data, but rather also includes text and graphical data transmissions.

A monitoring system 105 of an embodiment of the present invention monitors a RNC 112 in the UMTS 108. Each of the interfaces, Iub, Iur, an Iu are monitored for the RNC 112. The Iu interface generically refers to one or both of the Iu-cs and Iu-ps interfaces. A server then analyzes and correlates the data obtained by N of the monitoring systems 105 to allow N RNCs 112 to be monitored simultaneously from a central location. This simultaneous monitoring permits analysis and troubleshooting of the RNCs 112 on a per call basis even when the call is transferred between RNCs 112. N

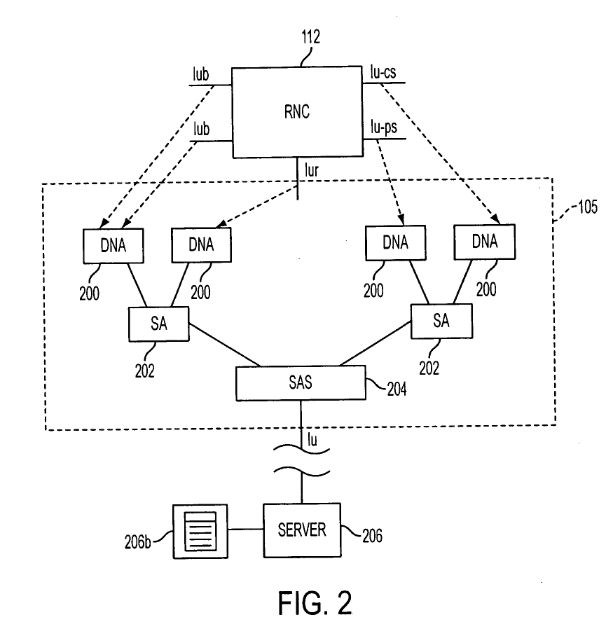

FIG. 2 is a block diagram illustrating a Radio Network Controller (RNC) and monitoring system, according to an embodiment of the present invention. The monitoring system 105 comprises distributed network analyzers 200, signaling analyzers 202, and a signaling analyzer server 204. In the embodiments of the present invention, other RNCs 112 are monitored simultaneously using the same structure as illustrated in FIG. 2, however, for clarity only one RNC is shown being monitored. The server 206 correlates data from N of the signaling analyzer servers 204 and displays the results on a user interface 206b.

The distributed network analyzers 200 are each coupled with an interface, lub, Iur, and lu of the RNC 112 to capture data. There will be a distributed network analyzer 200 coupled with at least one lub interface between the RNC 112 and at least one of the Node Bs 114. It is understood, that not all of the interfaces need to be monitored at any one time and various configurations are contemplated, for example, each lub interface and Node B may be monitored or every other one may be monitored or any number N. By capturing data from the Iur interface at the same time as the lub interfaces, signaling data for a call that has a soft handoff between RNCs 112 can be monitored and tracked. The captured data is signaling data that includes, for example, network signaling data, such as messages used by a communications network to setup and control the functions of the network. The signaling data can also include, for example, user data, such as information related to initiation of a session by a user to make a phone call, setup connection, etc., and application signaling data such as information used by applications to communicate with either other applications or a user.

The distributed network analyzers 200 might be for example, Agilent™ J6801A distributed network analyzer, which can be used for real time extraction of the signaling data and distribution of the signaling data. Further, Agilent™ network analyzer software, such as the J6840A, can be used for the parallel analysis of the signaling data. This enables the signaling data to be analyzed with respect to a call. While the network analyzers 200 are described using Agilent™ products, the present invention is not limited to use by Agilent™ products, as it is understood that other products and devices are available to capture signaling and user data from a communication interface.

The network analyzers 200 are interfaced with multiple signaling analyzers 202 that are used to analyze the captured data for various interfaces of a particular RNC 112 over time. For example, a first signaling analyzer 202 will analyze the data captured by the distributed network analyzers 200 coupled with the Iur interfaces of the RNC 112, and a second signaling analyzer 202 will analyze the data captured by the distributed network analyzers 200 coupled with the lub interfaces of the RNC 112. The signaling analyzers 202 are looking for predetermined data, signaling and user, representing an event of interest, for example, an error such as a dropped call, poor quality of service (QoS), etc. The signaling analyzers 202 may be personal computers running Agilen™ signaling analyzer software, such as the J7326A real time signaling analyzer software. For each group of distributed network analyzers 200, the signaling analyzers can look at desired features, such as multiple interface call/data session tracing, hardware filtering, and statistics of logged messages. Once the signaling analyzers 202 have analyzed the signaling data to locate a significant cellular network event (i.e., an error) for the signaling data captured by the distributed network analyzers reporting on an interface, the results will be transmitted to a signaling analyzer server 204.

There is a signaling analyzer server (SAS) 204 for each RNC 112 that is being monitored. This permits a scalable system for analyzing the interfaces of multiple RNCs 112 in the UMTS 108 and correlating events occurring in each of the RNCs 112. The SAS 204 correlates the disparate data from each of the signaling analyzers 202 so that each of the interfaces for which data is captured can be related to each other on a per call basis for the RNC 112. For example, when a call is initiated from user equipment 116 as it is transiting between cells the starting RNC 112 performs a soft handoff to another RNC 112. Thus, the starting lub interface and the starting Iur interface are transmitting signaling data related to the call to the other RNC 112 and through another lub interface to the user equipment 116. Since the SAS 204 for the starting RNC 112 and another SAS 204 for the other RNC 112 each perform analysis of the signaling data for the same call, the signaling data can be correlated on a per call basis across multiple RNCs 112 by a server 206. The server 206 will be described in more detail below. Each SAS 204 transmits a status report of predetermined significant events to the server 206 which generates results based on correlation of all of the status reports from each SAS 204 in the UMTS 108 corresponding to monitored RNCs 112. The server 206 then displays the results on a user interface 206b. The transmission from each SAS 204 to the server 206 is easily accomplished over the same UMTS 108 interfaces used by the RNCs 112. For example, each SAS 204 in each monitoring system 105 transmits the status report of the significant events noted by each signaling analyzer 202 coupled together by the SAS 204 via the lu interface to the server 206 at a remote location.

The server 206 may be a Network Troubleshooting Center (NTC) operating to analyze and correlate events from all the monitored RNCs 112 reported by each SAS 204 in each monitoring system 105. The server 206 communicating with each SAS 204 enables the user to view the status of N number of RNCs 112 in the UMTS 108 from a single location. The location may be at a central switching office or at some convenient location within the UMTS 108. The NTC is a known device such as, for example, Agilent™ NTC Model No. J6801A. The server 206 displays the correlated and analyzed events from multiple signaling analyzer servers 204 corresponding to multiple RNCs 112 as a controller report on some user interface 206b. The user interface 206b displays the correlated and analyzed events as a controller report to indicate the health of the RNCs 112 according to an easy visual display such as a graphic user interface (GUI). The GUI may be color coded for even faster recognition of the RNCs status. Alternatively, the display may be text or some other type of graphical indicator of the status of the RNCs 112 in the UMTS 108. Once the correlated events from all the signaling analyzer servers 204 are displayed the user may then view the events. If more information is desired, then the user may back track or drill down into the signaling data or user data by communicating a detailed data request to a specific SAS 204 for more detailed data report of the signaling data or user data that was logged by the SAS 204 for a particular RNC 112. This drill down may then proceed further all the way down to the distributed network analyzers 200 at each of the interfaces of the RNC 112.

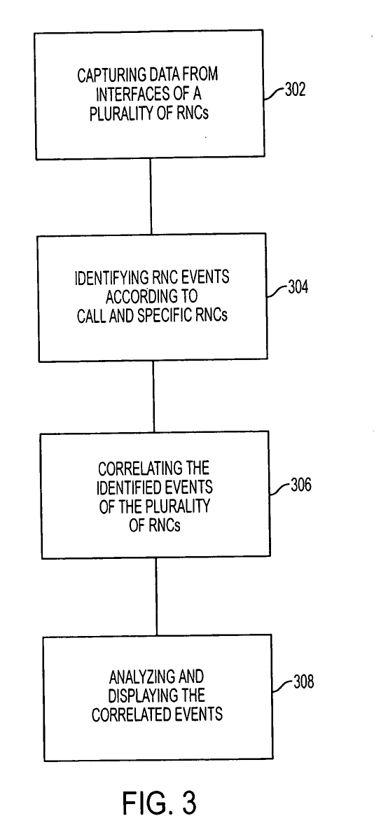

FIG. 3 illustrates an embodiment of a method of capturing data across interfaces of multiple radio network controllers (RNC) 112, distributing the captured data for correlation on a call basis and then correlating and displaying all the captured data corresponding to each of the multiple RNCs 112. At operation 302, data is captured across various interfaces of a plurality of radio network controllers in the UMTS 108 via a plurality of distributed network analyzers 200. Radio network controller 112 events of the captured data are identified according to a cell call for each radio network controller which handles the cell call according to analysis by signaling analyzers 202. The server 206 correlates the identified events from each signaling analyzer 202 corresponding to the captured data for each RNC 112 together according to the cell calls and each radio network controller. The correlated events are then displayed on a user interface 206b to permit monitoring of the plurality of RNCs 112 simultaneously. Accordingly, the method of the present invention allows real time distributed analysis of the data on the interfaces of multiple RNCs from a single location.

Accordingly, an embodiment proivides a method of monitoring a plurality of radio network controllers 112 in a cellular network (UMTS 108), by transmitting a first status report corresponding to detected network data of a first cell call, where the first cell call is associated with a first radio network controller, the status report being transmitted on a packet network connection (Iu) connecting the first radio network controller with the cellular network, detecting other network data of another cell call on the cellular network corresponding to another radio network controller; transmitting a second status report corresponding to the other network data of the other cell call, the second status report being transmitted on the packet network connection (Iu) connecting the other radio network controller with the cellular network; and correlating and displaying the first status report and the second status report for the first cell call and the other cell calls as a radio network controller report to a user. The user may then transmit a detailed data request to one of the radio network controllers for more detailed data regarding the first or other cell call. This method permits the user to view multiple RNCs simultaneously to have a better understanding of the performance of the cellular network, particularly where multiple RNCs are involved through soft handoffs with a single cell call.

The present invention also provides a method of monitoring a cellular network, the cellular network including a first radio network controller, a first plurality of Node Bs corresponding to the first radio network controller, a second radio network controller and a second plurality of Node Bs corresponding to the second network controller. Data flowing between the first radio network controller and each Node B of the first plurality of Node Bs is captured and similar captures occur for the data flowing between the second radio network controller and each Node B of the second plurality of Node Bs. Additionally, data flowing between the first radio network controller and the second radio network controller is captured to present a more complete picture of the signaling and processing occurring at the radio access network level. Though only two radio network controllers are described any number N of radio network controllers may be monitored in the same way. The captured data is correlated by a server according to a call and a report is generated of the correlated data so that the status of the first and second radio network controllers may be determined according to the correlated captured data. This provides a view of the signaling data for multiple radio network controllers throughout the cellular network enabling better troubleshooting. Looking at a report of the signaling data across multiple radio network controllers simultaneously can identify errors occurring in the cellular network more quickly and easily.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A method monitoring a cellular network, comprising:
capturing data across interfaces of a plurality of radio network controllers in the cellular network via a plurality of distributed network analyzers;
identifying radio network controller events of the captured data according to a cell call for each radio network controller which handles the cell call according to analysis by signaling analyzers;
correlating together the events identified by the signaling analyzers according to the cell call.

2. The method of claim 1, wherein the radio network controller interfaces comprise Iub, Iur and Iu data related to the radio network controllers.

3. The method of claim 1, wherein the captured data is analyzed on a real-time basis.

4. The method of claim 1, wherein the captured data is analyzed offline.

5. The method of claim 1, further comprising:
determining whether the correlated data represents a cellular network event;
identifying one of the radio network controllers that handled the call corresponding to the cellular network event; and
displaying the correlated data and the identified one of the radio network controllers.

6. The method of claim 5, further comprising:
transmitting a detailed data request to the identified one of the radio network controllers corresponding to the cellular network event; and
receiving a detailed data report of the one of the radio network controllers in response to the detailed data request based on the captured data of a selected portion of the distributed network analyzers corresponding to the one radio network controller.

7. A method of monitoring a cellular network, the cellular network including a core network communicating with a first radio network controller, the first radio network controller having a first plurality of Node Bs corresponding to the first radio network controller, and a second radio network controller, the second radio network controller having a second plurality of Node Bs corresponding to the second radio network controller, the method comprising:
capturing first data flowing between the first radio network controller and at least one Node B of the first plurality of Node Bs;
capturing second data flowing between the second radio network controller and at least one Node B of the second plurality of Node Bs;
capturing third data flowing between the first radio network controller and the second radio network controller;
correlating the captured first, second and third data according to a call; and
determining status of the first and second radio network controllers according to the correlated first, second and third data.

8. The method of claim 7, wherein the captured first and second data comprises lub data and the captured third data comprises Iur data.

9. The method of claim 7, further comprising:
capturing fourth data flowing between the first radio network controller and the core network;
capturing fifth data flowing between the second radio network controller and the core network; and
correlating the fourth and fifth data together with the first, second and third data.

10. The method of claim 7, wherein the determining status comprises:
determining whether the correlated data represents a cellular network event;
identifying one of the first radio network controller or the second radio network controller that handled the call corresponding to the cellular network event; and
displaying a controller report on a user interface.

11. The method of claim 10, wherein the controller report comprises a summary of the correlated captured first, second and third data.

12. The method of claim 11, further comprising:
transmitting a detailed data request to the one radio network controller that handled the call corresponding to the cellular network event; and
receiving a detailed data report of the one radio network controller in response to the detailed data request.

13. A method of monitoring a plurality of radio network controllers in a cellular network, comprising:
transmitting a first status report corresponding to detected network data of a first cell call, where the first cell call is associated with a first radio network controller, the status report being transmitted on a packet network connection connecting the first radio network controller with the cellular network;
detecting other network data of another cell call on the cellular network corresponding to another radio network controller;
transmitting a second status report corresponding to the other network data of the other cell call, the second status report being transmitted on the packet network connection connecting the other radio network controller with the cellular network; and
correlating and displaying the first status report and the second status report for the first cell call and the other cell call as a radio network controller report corresponding to the first and the other radio network controller to a user.

14. The method of claim 13, wherein the network data comprises signaling data and user data.

15. The method of claim 13, wherein the network data comprises at least one of Iub, Iur, Iue or Iu radio network controller data.

16. The method of claim 13, wherein the correlating and displaying comprises:
determining whether the correlated radio network controller report represents a cellular network event;
identifying one of the radio network controllers that handled the cell call corresponding to the cellular network event; and
displaying the correlated radio network controller report including urgency information regarding the cellular network event.

17. The method of claim 16, wherein the urgency information is at least one of text information, a graphical representation or a color coded graphic according to a type of the cellular network event.

18. The method of claim 16, further comprising:
transmitting a detailed data request to the one radio network controller that handled the cell call corresponding to the cellular network event; and
receiving a detailed data report of the network data of the one radio network controller in response to the detailed data request.

19. An apparatus for monitoring a cellular network, comprising:
means for capturing data from interfaces of a plurality of radio network controllers in the cellular network; and
means for simultaneously correlating the captured data and displaying the correlated captured data on a user interface.

20. The apparatus of claim 19, wherein the data comprises signaling data and user data.

21. A method, comprising:
monitoring simultaneously a plurality of radio network controllers on a real-time basis in a cellular network from a user terminal.
